(19) United States
(12) Patent Application Publication
(10) Pub. No.: US 2025/0049196 A1
(43) Pub. Date: Feb. 13, 2025

(54) DRYING APPARATUS AND CONTROL METHOD

(71) Applicant: SZ ZUVI TECHNOLOGY CO., LTD., Shenzhen (CN)

(72) Inventors: Langyu HU, Shenzhen (CN); Xingwang XU, Shenzhen (CN); Lingdong GU, Shenzhen (CN)

(73) Assignee: SZ ZUVI TECHNOLOGY CO., LTD., Shenzhen (CN)

(21) Appl. No.: 18/931,019

(22) Filed: Oct. 29, 2024

Related U.S. Application Data
(63) Continuation of application No. PCT/CN2022/125835, filed on Oct. 18, 2022.

(51) Int. Cl. A45D 20/12; F26B 21/10

(52) U.S. Cl. CPC A45D 20/12; F26B 21/10; A45D 2200/205

(57) ABSTRACT

A drying apparatus (10) and a control method, wherein the drying apparatus (10) comprises: an airflow generating element (11), a heating element (12), a barometer (13) and a main control module (14). The airflow generating element (11) is configured to generate an airflow. The heating element (12) is configured to heat the airflow. The barometer (13) is configured to obtain an ambient pressure. The main control module (14), coupled to the heating element (12), and the barometer (13), is configured to adjust the power of the heating element (12) according to the ambient pressure.

### CROSS-REFERENCE TO RELATED APPLICATIONS

This application is a continuation of International Patent Application No. PCT/CN2022/125835, filed on Oct. 18, 2022, the contents of which are hereby incorporated by reference.

### TECHNICAL FIELD

The present disclosure is related to the technical field of a drying apparatus, and in particular, to a drying apparatus and control method.

### BACKGROUND

A drying apparatus is capable of emitting a heated airflow to accelerate an evaporation of water of a target object for the purpose of drying. For example, after shampooing, a person uses a hair dryer to dry his hair with hot airflow.

In the drying apparatus in the prior arts, temperature control is generally implemented through air temperature feedback loop; that is, a temperature sensor is configured near the air outlet to obtain the air temperature, and then the heating power is adjusted according to the obtained air temperature. This method of temperature control has at least one of the following drawbacks:
(1) Because the temperature control process needs to obtain temperature of the heated airflow as a basis for feedback adjustment, there is a lag in the temperature control, especially when the initial air temperature of the drying apparatus is too high, even if the air temperature can be reduced in the future, the high-temperature airflow emitted may still burn the user.
(2) Limited by factors such as installation space and circuit design, a thermistor (e.g., NTC) is generally used as a component for detecting air temperature in the prior arts. The resistance and temperature changes of the thermistor are non-linear, and the detection accuracy will be greatly reduced in the high temperature range (such as above 100° C.), and the thermistor itself also has installation errors, which together lead to poor detection accuracy of the thermistor, and may only indicate an approximate air temperature range. Therefore, the control of air temperature in the prior arts is limited to setting a high temperature threshold to avoid excessive air temperature, and cannot accurately control to reach a specific air temperature.

### SUMMARY

The disclosure provides a drying apparatus and a control method, in order to solve the problem that the drying apparatus in the prior arts has low precision in controlling air temperature and may emit airflow at excessive initial air temperature.

The disclosure provides a drying apparatus, comprising: an airflow generating element, a heating element, a barometer and a main control module, the airflow generating element is configured to generating an airflow, the heating element is configured to heat the airflow, the barometer is configured to obtain an ambient pressure, the main control module is coupled to the heating element and the barometer, and the main control module is configured to control the heating element according to the ambient pressure.

The disclosure also provides a method for controlling an air temperature of the output airflow of the drying apparatus, comprising the following steps:
obtaining the ambient pressure through the barometer;
controlling the airflow generating element and/or the heating element according to the ambient pressure, the heating element is configured to heat the airflow, and the airflow generating element is configured to generate the airflow.

The disclosure also provides a readable storage medium, the readable storage medium stores a program executed by a processor, and steps of the foremost method are implemented.

The drying apparatus and a method in the disclosure change the heating power of the heating element through the change of the ambient pressure where the drying apparatus operates, so as to achieve a precise control of air temperature.

Additional aspects and advantages of embodiments of the present disclosure will be given, in part, in the following detailed description, part of which will become apparent from the following detailed description or will be learned through the implementation of the present disclosure.

### BRIEF DESCRIPTION OF THE DRAWINGS

The foregoing and/or additional aspects and advantages of the present disclosure will become apparent and readily understood from the detailed description of the embodiments in conjunction with the following accompanying drawings, wherein:

FIG. 1 is a schematic diagram of a frame structure of a drying apparatus in accordance with embodiments of the present disclosure;

FIG. 2 is a schematic diagram of a heating element in accordance with embodiments of the present disclosure;

FIG. 3 is a schematic diagram of a frame structure of a drying apparatus in accordance with embodiments of the present disclosure;

FIG. 4 is a schematic diagram of a structure of a drying apparatus in accordance with embodiments of the present disclosure;

FIG. 5 is a schematic diagram of a structure of a drying apparatus in accordance with embodiments of the present disclosure;

FIG. 6 is a schematic diagram of a structure of a drying apparatus in accordance with embodiments of the present disclosure;

FIG. 7 is a schematic diagram of steps of a control method in accordance with embodiments of the present disclosure;

FIG. 8 is a schematic diagram of detailed steps of a control method in accordance with embodiments of the present disclosure;

FIG. 9 is another schematic diagram of detailed steps of the control method in accordance with embodiments of the present disclosure;

FIG. 10 is another schematic diagram of detailed steps of the control method in accordance with embodiments of the present disclosure;

FIG. 11 is another schematic diagram of detailed steps of the control method in accordance with embodiments of the present disclosure;

FIG. 12 is another schematic diagram of detailed steps of the control method in accordance with embodiments of the present disclosure; and

FIG. 13 is another schematic diagram of detailed steps of the control method in accordance with embodiments of the present disclosure.

### DETAILED DESCRIPTION

The embodiments of the present disclosure are described in detail below, and examples of said embodiments are shown in the drawings wherein the same or similar designations denote the same or similar elements or elements having the same or similar functions throughout. The embodiments described below by reference to the drawings are illustrative and are intended to explain the embodiment of the present disclosure only and should not be construed as a limitation on the embodiment of the present disclosure.

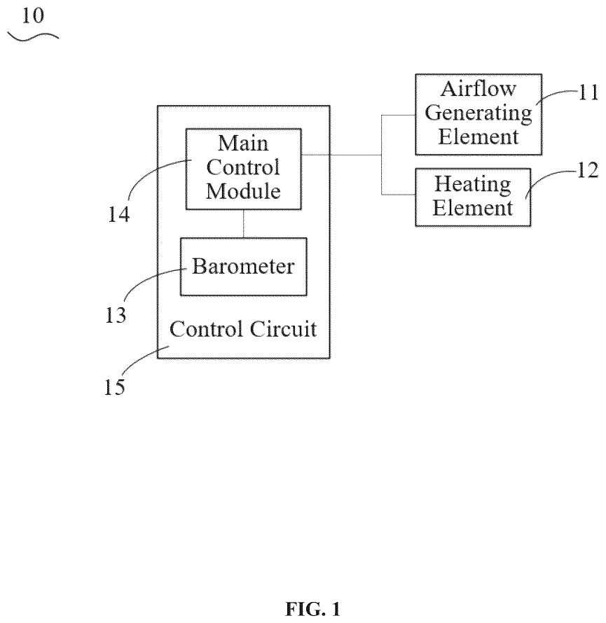

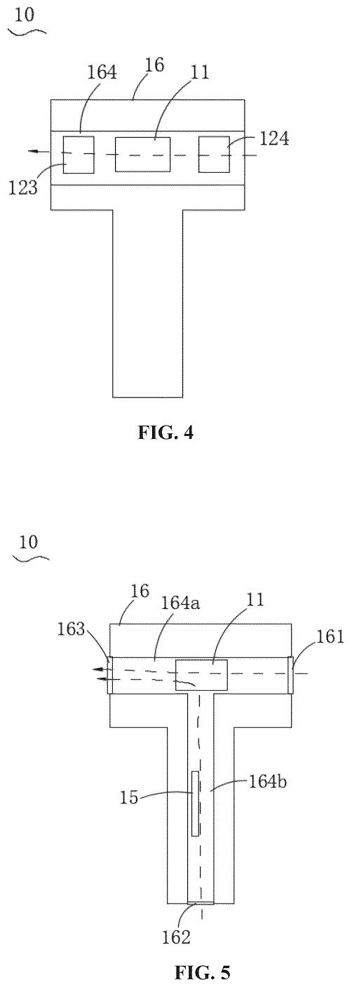

As shown in FIG. 1 and FIG. 4, a drying apparatus 10 is provided in the embodiment of the present disclosure, comprising an airflow generating element 11, a heating element 12, a barometer 13, and a main control module 14.

The airflow generating element 11 may include a motor and an impeller. When the airflow generating element 11 is in operation, the impeller is driven to rotate by the motor, and the rotating impeller does work on the air and causes the air to flow to produce an airflow (the direction of the airflow is shown by the arrow in FIG. 4).

The heating element 12 may include a plurality or groups of electric heating wires, electric heating sheets or other structures. After electronic current is input to the heating element 12, the heat dissipated by the heating element 12 is transmitted to airflow nearby to heat it. The heating element 12 is at least partially configured in the airflow formed by the airflow generating element 11, and the heat generated by the heating element 12 is convective to the airflow passing through, so that the drying apparatus 10 may emit a hot airflow to dry a target.

The barometer 13 is a module for obtaining ambient pressure.

In some embodiments, the barometer 13 itself can directly detect and obtain ambient pressure. For example, the barometer 13 is a barometric pressure sensor (an altitude sensor, or an altitude sensor), a barometer and the like. When the barometer 13 is located in a non-confined space, the ambient pressure at such location can be detected and obtained by its contacting the air.

In some embodiments, the barometer 13 can also be a GPS module, and the altitude of the position can be obtained through a GPS signal, and the ambient pressure is obtained after being converted according to the altitude. Or, the location can be obtained through GPS signals, such as the location of Beijing, and the ambient pressure of Beijing can be looked up according to the preset map data.

In some embodiments, the barometer 13 may also communicate with other modules to obtain ambient pressure. For example, the drying apparatus 10 may establish communication with intelligent terminals such as mobile phones, tablets, PCs by Bluetooth, WiFi, etc., and the barometer 13 directly obtains the ambient pressure of the position from the intelligent terminal. Or the barometer 13 obtains the location from the intelligent terminal, and the ambient pressure of the location is obtained by looking up the preset map data. Alternatively, the barometer 13 communicates directly with relevant barometer(s) to obtain the ambient pressure.

In some embodiments, the barometer 13 may also obtain ambient pressure after being connected to a network. For example, the drying apparatus 10 itself can access the Internet by WiFi or mobile network; and after locating its position through the network, the ambient pressure of the location is obtained by looking up the preset map data. Alternatively, after the drying apparatus 10 is connected to the network, the barometer 13 can receive the ambient pressure information from a server end.

In some embodiments, the barometer 13 may also be an input module such as a button, a touch screen, etc.; and the user finds the ambient pressure by himself and inputs the ambient pressure value through the input module.

In some embodiments, the barometer 13 of the drying apparatus 12 may also be pre- calibrated in batches; and the barometer 13 is only used as a storage module to store the pre- calibrated ambient pressure. When the drying apparatus 12 is on a market for sale, the ambient pressure of the corresponding sale area is pre-calibrated, and the drying apparatus 12 purchased by local users may already have its ambient pressure calibrated.

The various embodiments of the barometer 13 are listed above, and unless otherwise specified below, the barometer 13 refers to a barometric pressure sensor (an altitude sensor, or an altitude sensor), which is directly in contact with air and detects and obtains ambient pressure.

The main control module 14 is an electrical module carrying out data operation, such as a MCU (single-chip microcomputer), a CPU (central processing unit) and the like. When the drying apparatus 10 is in operation, the main control module 14 may obtain an ambient pressure from the barometer 13 and control operation parameters of the drying apparatus 10. The operation parameters specifically comprise the rotational speed of the motor of the airflow generating element 11 and/or the power of the heating element 12. By adjusting the control parameters, the airflow speed of the output airflow from the airflow generating element 11 and/or the heat generated from the heating element 12 may be changed, that is, the air temperature and the airflow speed of the drying apparatus 10 may be changed.

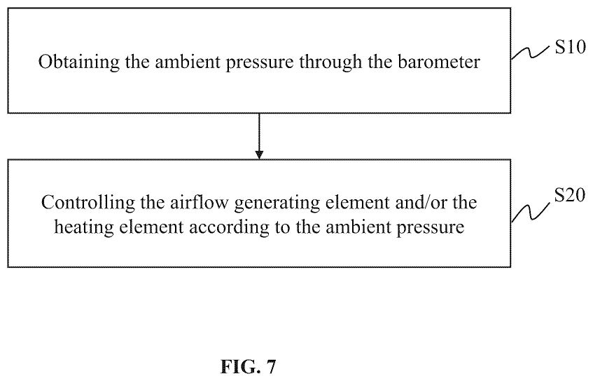

Correspondingly, as shown in FIG. 1 and FIG. 7, a method is provided in some embodiments of the present disclosure for controlling the drying apparatus 10 described above, comprising the following steps:
S10: obtaining the ambient pressure through the barometer 13;

The ambient pressure is obtained through the barometer 13, and refers to the ambient pressure value of the open environment where the drying apparatus 10 is operated, that is, the ambient pressure value of the area where the user is using the drying apparatus 10. The mode of obtaining ambient pressure through the barometer 13 can refer to a variety of embodiments listed in the previous article, and will not be repeated.
S20: controlling the airflow generating element and/or the heating element according to the ambient pressure.

The main control module 14, taking the ambient pressure as one of the basis for changing the control parameter, changes the control parameter according to different ambient pressure, such as increasing or decreasing the power value of the heating element 12, increasing or decreasing the speed of the airflow generating element 11, in order to adjust the operation of the drying apparatus 10 according to change of the ambient pressure.

According to the drying apparatus 10 and the control method of the embodiment, the main control module 14 correspondingly changes the control parameters of the drying apparatus 10 by detecting change of ambient pressure, so that the user in different altitude areas can have a similar and conforming user experience when using the drying apparatus 10. In particular, it is possible to avoid problems such as high air temperature and slow drying speed due to changes in ambient pressure, and the specific control process is described in detail below.

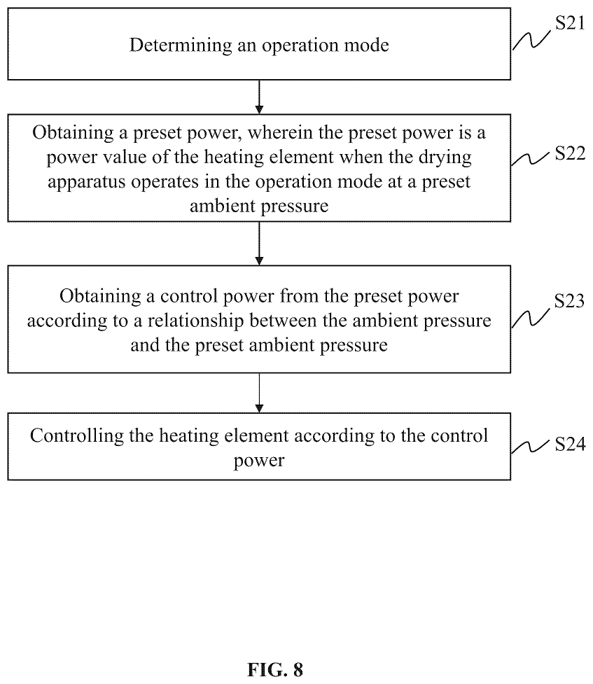

In some embodiments, as shown in FIG. 7 and FIG. 8, in step S20, controlling the airflow generating element and/or the heating element according to the ambient pressure, specifically comprising:
S21: determining an operation mode.

The drying apparatus 10 is generally preset with one or more operation modes, with each operation mode with different design purposes that corresponding to different control parameters.

For example, the drying apparatus 10, which may be a hair dryer, may have three preset operation modes according to drying speed: COLD, MEDOIM, HOT; Or three preset operation modes according to drying time: LOW, MEDIUM, HIGH. When the user switches on to use the drying apparatus 10, the drying apparatus 10 shall be in a certain operation mode. During the design of the Drying Apparatus 10, the required airflow speed, and air temperature are determined according to the design purpose of the operation mode, and the heating element 12 and/or the airflow generating element 11 are calibrated to determine the control parameters of the corresponding operation mode. Specifically, the control parameters comprise the rotational speed of the airflow generating element 11 and/or the power value of the heating element 12. When the drying apparatus 10 is in different operation modes, the main control module 14 controls the operation of the airflow generating element 11 and/or the heating element 12 according to the corresponding control parameters.

It is easy to understand that, in some embodiments, the drying apparatus 10 may not have a plurality of operation modes. For example, the drying apparatus 10 may be a hand dryer, which only has two states of on and off. The airflow speed and air temperature of the hand dryer during operation will also be determined in the early design process, and the corresponding control parameters are calibrated. In other words, the operation mode of the hand dryer refers to the states of switch on and off.
S22: obtaining a preset power, wherein the preset power is a power value of the heating element 12 when the drying apparatus 10 operates in the operation mode at a preset ambient pressure.

During the design of the drying apparatus 10, the operating parameters of each operation mode are calibrated based on the preset ambient pressure, which at least comprises the power value of the heating element 12, that is, the preset power corresponds to the preset ambient pressure.

For example, an operation mode of the drying apparatus 10 is designed to emit an airflow with air temperature at 60° C.; and the preset power of the heating element 12 of this operation mode with the preset ambient pressure is determined to be W1 by simulation, experimental test and so on. That is, in the preset ambient pressure environment, when the air temperature of the airflow emitted by the drying apparatus 10 in this operation mode is 60° C., the power value of the heating element 12 is at the preset power W1.
S23: obtaining a control power from the preset power according to a relationship between the ambient pressure and the preset ambient pressure.

When the drying apparatus 10 operates in different areas, there may be differences between the ambient pressure and the preset ambient pressure. For example, the ambient pressure is greater than the preset ambient pressure, or the ambient pressure is less than the preset ambient pressure. In these cases, if the main control module 14 still adopts the preset power to control the heating element 12, the design purpose of this operation mode cannot be achieved due to actual air temperature changes from the ambient pressure changes. Therefore, the main control module 14 needs to obtain the control power by adjusting the preset power according to a relationship between the ambient pressure and the preset ambient pressure, so that when the drying apparatus 10 operates in the same operation mode with different ambient pressure, it can achieve the same design purpose as with the original preset ambient pressure.

It is easy to understand that, if the ambient pressure and the preset ambient pressure are the same (e.g., if the absolute value of the difference between the two is less than the threshold, they can be regarded as the same), then the main control module 14 can directly take the preset power as the control power.
S24 controlling the heating element 12 according to the control power.

The main control module 14 controls the operation of heating element 12 to adapt to the control power of current ambient pressure, and the drying apparatus 10 can achieve the same design purpose as the original preset ambient pressure of the corresponding operation mode.

In the control method of the above-mentioned embodiment, the control parameters of each operation mode are calibrated in the preset ambient pressure during design of the drying apparatus 10. It may also be understood that the relevant data pre-stored in the drying apparatus 10 comprises the control parameters and the preset ambient pressure corresponding to the control parameters. During operation of the drying apparatus 10, the main control module 14 obtains the control power that adapts to the ambient pressure from the preset power according to a relationship between the ambient pressure and the preset ambient pressure actually detected.

In other words, the ambient pressure is introduced as one of the control basis in the control process of the drying apparatus 10, so that the drying apparatus 10 adaptively adjusts its operating parameters in various ambient pressures. No matter where the user operates the drying apparatus 10 using the same operation mode, the drying apparatus 10 can achieve the design purpose of the operation mode, and the use experience may also roughly be the same.

As shown in FIG. 9, in the control method of some embodiments, different operation modes correspond to different air temperatures, and the air temperature is configured to characterize temperature of an output airflow of the drying apparatus 10.

The drying apparatus 10 may have more than ten operating modes designed to emit airflow with different air temperatures. In a specific embodiment, three operation modes are preset with different air temperatures: COLD (e.g., air temperature is ambient temperature), MEDIUM (e.g., air temperature at 60° C.), HOT (air temperature at 80° C.), which is informed to the user in the manual, packaging box, display screen, etc., and the user selects the operation mode during operation according to his/her own needs. During the design of the drying apparatus 10, the power value of the heating element 12 in the above three operation modes is calibrated according to the preset ambient pressure, wherein the preset power corresponding to the COLD mode is zero, the preset power corresponding to the MEDIUM mode is W₁, and the preset power corresponding to the HOT Mode is W₂. It can be understood that, in the preset ambient pressure, when the main control module 14 controls the heating element 12 to operate at the preset power W1, the air temperature of the output airflow of the drying apparatus 10 may be at 60° C., and when the main control module 14 controls the heating element 12 to operate at the preset power W2, the air temperature of the output airflow of the drying apparatus 10 may be at 80° C. When the user operates the drying apparatus 10, the closer the actual air temperature in each operation mode is to the above value, the better the use experience is. On the contrary, if the user in different regions operates the drying apparatus 10, the air temperature in each operation mode deviates from the above-mentioned value, and the user will feel that the actual air temperature of the drying apparatus 10 is obviously different from the declared air temperature, thereby bringing a poor use experience.

For this purpose, in step S23, obtaining a control power from the preset power, which specifically comprises:
S231: if the ambient pressure is greater than the preset ambient pressure, obtaining the control power by increasing the preset power;
S232: if the ambient pressure is less than the preset ambient pressure, obtaining the control power by decreasing the preset power.

According to relevant aerodynamic equation, it can be seen that the change of ambient pressure will affect the air temperature of the output airflow of the drying apparatus 10. The specific principle is that: under different ambient pressure, the total mass of gaseous substances contained in the same volume of air is different. When the same total heat is transmitted to the same volume of air, if the air contains more mass of gaseous substances, the air will heat up less, and if the air contains less mass of gaseous substances, the air will heat up more.

For example, when a drying apparatus 10 operates in region A where the ambient pressure is P1, the total volume of the output airflow of the drying apparatus 10 is S, the power value of the heating element 12 is Wₐ, and the air temperature of the output airflow of the drying apparatus 10 is T1. When the drying apparatus 10 operates in region B where the ambient pressure is P2(P2<P1), with the same control parameters adopted, the airflow with a total volume of S is also output per unit time, the heating power of the heating element 12 is also Wₐ, and the air temperature of the output airflow of the drying apparatus 10 is T2.

Due to the difference in ambient pressure between the two regions, the air with volume S contains more mass of gaseous matter in region A, while the air with volume S contains less mass of gaseous matter in region B. Therefore, when the user operates the drying apparatus 10 in these two regions, under the premise that the power value Wₐ of the heating element 12 remains unchanged, the total heat input from the heating element 12 to the air with volume S per unit time is the same, but because the quality of the gaseous substances contained is different, the air temperature T1, as a result, is less than the air temperature T2.

That is to say, when the user operates the drying apparatus 10 in different regions, even if the operating parameters of the drying apparatus 10 are exactly the same, he/she may feel different air temperatures. Specifically, the lower the ambient pressure, the higher the air temperature, while the higher the ambient pressure, the lower the air temperature.

Not only does the air temperature affect the user's body experience, but also an airflow with high air temperature may burn the user's skin or ignite flammable materials. If the design and production of the drying apparatus 10 is completed in region A, its air temperature is slightly lower than the temperature that may burn the skin or ignite flammable materials in an operation mode with the highest air temperature. If the influence of ambient pressure on air temperature is not considered, the actual air temperature of the output airflow will exceed the above temperature when the user operates the drying apparatus 10 in the same operation mode in region B, thus causing a high temperature hazard.

Based on the above-mentioned principle, it can be known that under the premise that the control parameters remain unchanged, the air temperature of output airflow of drying apparatus 10 in an environment of high ambient pressure will decrease, while the air temperature of output airflow in another environment of low ambient pressure will increase. In order to have the same air temperature in the same operation mode of the output airflow of the drying apparatus 10 at any ambient pressure, in the embodiment of the present disclosure, when the ambient pressure is greater than the preset ambient pressure, the control power is obtained by increasing the preset power, so that the heat from the heating element 12 to the airflow is increased, fulfilling the purpose of increasing the actual air temperature. In the same way, if the ambient pressure is less than the preset ambient pressure, the control power is obtained by decreasing the preset power, thereby reducing the heat from the heating module 12 to the airflow, and fulfilling the purpose of reducing the actual air temperature. In this way, the precise control of air temperature can be achieved. When the user in any region operates the drying apparatus 10 with the same operation mode, the output airflow shall have the same air temperature, which conforms to the preset air temperature of this operation mode of drying apparatus 10, thereby brings better use experience.

In particular, in a region with low ambient pressure, when the user operates the drying apparatus 10 in an operation mode with the maximum air temperature, if the influence of ambient pressure on the air temperature is not considered, the danger caused by hot air temperature of the drying apparatus 10 may occur. Although the heating power to the airflow can be adjusted by detecting the air temperature according to the prior art, this adjustment mode lags the actual change of the air temperature. Moreover, the danger caused by the initial air temperature being too high cannot be avoided. The control method in the above-mentioned embodiment of the present disclosure directly reduces the power value of the heating element 12 when the ambient pressure is detected to be low, thereby completely avoiding the danger that the initial air temperature is too high. In the same way, in a region with high ambient pressure, the control method in the above- mentioned embodiment of the present disclosure may increase the power value of the heating element 12 according to the ambient pressure, so that the air temperature of the output airflow will not be too low. In contrast, the air temperature of the output airflow of the drying apparatus 10 according to the prior art in the same situation will be lower, which may make users feel cold.

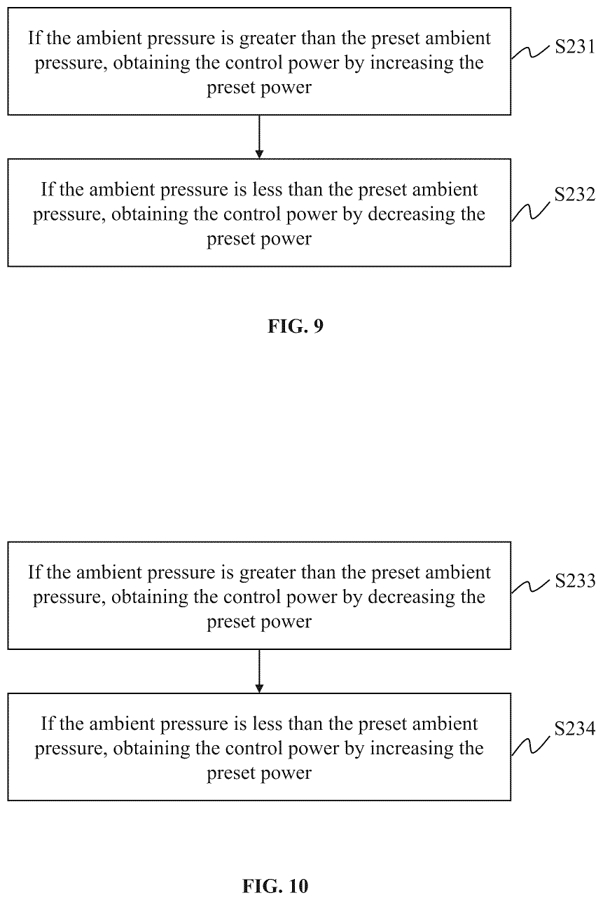

As shown in FIG. 10, in some embodiments, the control method may have different operation modes corresponds to different drying times, and the drying time is configured to characterize time taken by the drying apparatus 10 to dry a target from a first moisture level to a second moisture level.

For example, the drying apparatus 10 may be a hair dryer, and the target selected may be medium-length hair (e.g., the length is about 30 cm). In general, the water weight may account for about 30% of the total weight of the hair when the hair is completely wet with droplets wiped out from hair surface. The percentage changes to 15% of the total weight of the hair when the hair is roughly dried. A first moisture level of the target (e.g., hair) may be set at 30%, while a second moisture level may be set at 15%. The drying time is the time took by the drying apparatus 10 to dry the hair from the 30% moisture level to the 15% moisture level.

Multiple operation modes are configured to correspond to different drying times. For example, three operation modes may be preset: SLOW (e.g., drying time around 15 minutes), MEDIUM (e.g., drying time around 10 minutes), and FAST (e.g., drying time around 7 minutes). The user is informed of the drying time of these three operation modes in the manual, packaging box, display screen, etc. The user may select an operation mode to dry his/her hair according to needs, and the user may expect the drying process completed within the corresponding drying time. The closer the actual operating time is to the drying time corresponding to the operation mode, the better the user experience. On the contrary, if there is a significant difference between the time taken by the drying apparatus 10 to complete the drying and the declared drying time in each operation mode, the user, who operates the drying apparatus 10 in different regions, may have poor experience.

It should be noted that the shorter the time spent on drying, the faster the hair loses water, and the more likely the hair will suffer excessive water loss and heat damage. Based on different hair quality and user habits, different users may choose different drying times when drying hair with the drying apparatus 10. For example, users with short hair or less sensitive hair texture, in order to dry hair quickly to save time, may choose an operation mode with the shortest drying time. On the other hand, users with medium-long hair or sensitive hair texture, in order to dry hair slowly, may choose an operation mode with a longer drying time. Multiple modes of operation are configured to meet the needs of these different users.

In step S23, the obtaining the control power from the preset power, comprising:
S233: if the ambient pressure is greater than the preset ambient pressure, obtaining the control power by increasing the preset power;
S234: if the ambient pressure is less than the preset ambient pressure, obtaining the control power by decreasing the preset power.

According to the relevant aerodynamic equations, the total mass of the gaseous substances contained in the same volume of air is different under different ambient pressures. Moreover, the total mass of gaseous substances in the air is proportional to its water absorption capacity. In other words, given the same volume of air, when the ambient pressure is high, its water absorption capacity is stronger, so the drying efficiency on the target is higher, while when the ambient pressure is low, its water absorption capacity is weaker, so the drying efficiency on the target is lower.

For example, when a drying apparatus 10 operates in region A with an ambient pressure at P₁, the total volume of the output airflow of the drying apparatus 10 per unit time is S, the power value of the heating element 12 is W_{b}, and the drying time took by a medium length wet hair from 30% moisture level to 15% is t₁. When the Drying Apparatus 10 operates in region B with the ambient pressure at P₂(P₂<P₁), the total volume of the same output airflow of the drying apparatus 10 per unit time is S, the heating power of the heating element 12 is also W_{b}, and the drying time took by the same length wet hair from 30% moisture level to 15% is t₂.

Due to different ambient pressure between the two regions, in region A, the air with volume S contains more mass of gaseous substances and therefore has a stronger water absorption capacity, while, in region B, the air with volume S contains less mass of gaseous substances and therefore has a weaker water absorption capacity. When the user operates the drying apparatus 10 in these two regions, under the premise that the power value W_{b} of the heating element 12 remains unchanged, the water absorption capacity is different due to different quality of the gaseous substance, the drying time t₁ will be longer than the drying time t₂.

That is, when the user operates the drying apparatus 10 in different regions, even if the control parameters of the drying apparatus 10 are exactly the same, the drying time experienced may be different. Specifically, the lower the ambient pressure, the longer the drying time, while the higher the ambient pressure, the shorter the drying time.

Based on the above principle, it can be known that under the premise that the control parameters remain unchanged, the drying time of the drying apparatus 10 will decrease in an environment of high ambient pressure, while the drying time will increase in an environment of low ambient pressure. In order to have the same drying time for the drying apparatus 10 under the same operation mode in any ambient pressure, in the embodiment of the present disclosure, when the ambient pressure is greater than the preset ambient pressure, the control power is obtained by decreasing the preset power, so the drying time is increased. Similarly, if the ambient pressure is less than the preset ambient pressure, the control power is obtained by increasing the preset power, thereby reducing the drying time. In this way, the precise control of drying time can be achieved. When the user, in any region, operates the drying apparatus 10 with the same operation mode, the drying time taken to complete the drying is approximately the same, and the drying time conforms to the drying time the user normally experienced from the operation mode of the drying apparatus 10, thereby offering better use experience.

It should be noted that among the various embodiments described above, the various operation modes are not mutually exclusive. For example, in some embodiments, the drying apparatus 10 may have three operation modes: COLD (e.g., output airflow at room temperature), FAST (e.g., drying time around 7 minutes), HIGH (e.g., air temperature around 80° C.). The user selects different operation modes and obtains the corresponding control power according to the corresponding steps in the above-mentioned control method. In some embodiments, a specific operation mode may also be combined with the above two modes. For example, the operation mode is: HAIR CARE, which is designed to achieve a balance between fast drying and hair quality damage reduction. Its control logic may be that, the first stage features a continuous output airflow of air temperature at 80° C. for t₁ duration, and the second stage completes the drying process within t₂ duration. In the above two stages, different control logic may also be adopted according to the above-mentioned embodiment mode to obtain the corresponding control power.

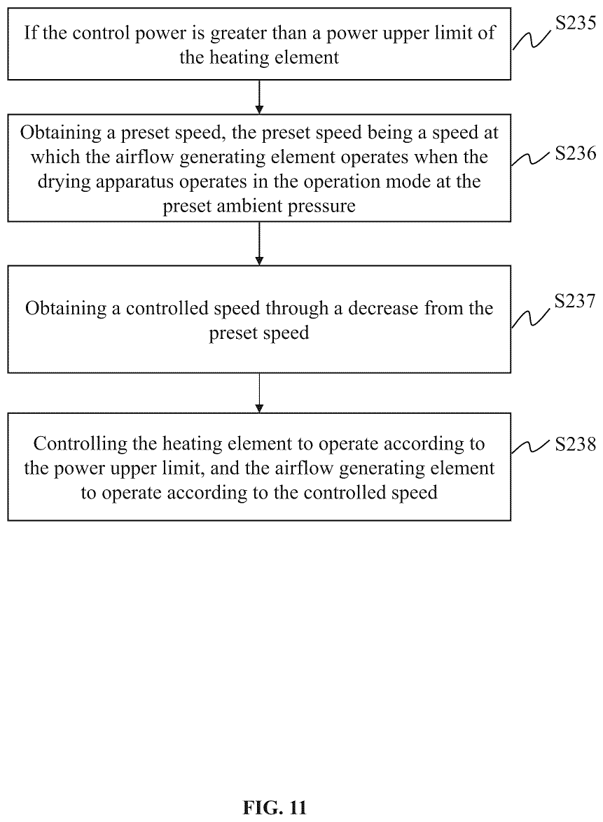

As shown in FIG. 11, in the control method of some embodiments, in step S20, controlling the airflow generating element 11 and/or the heating element 12 according to the ambient pressure, further comprises:
S235: if the control power is greater than a power upper limit of the heating element 12;

In some embodiments of the disclosure, the control power is obtained by increasing the preset power. If the preset power itself is already a power value close to a power upper limit of the heating element 12 (for example, in an operation mode with the maximum air temperature), the control power obtained through further increase may exceed the power upper limit of the heating element 12. The heating element 12 cannot operate with the control power, thereby causing the drying apparatus 10 to fail its purpose in this operation mode. For example, the corresponding air temperature or drying time cannot be reached in a region with high ambient pressure.
S236: obtaining a preset speed, the preset speed being a speed at which the airflow generating element 11 operates when the drying apparatus 10 operates in the operation mode at the preset ambient pressure.

During the design of drying apparatus 10, in the preset ambient pressure, the control parameters of each operation mode calibrated comprise preset power and preset airflow speed. That is, in the preset ambient pressure, the main control module 14 controls the heating element to operate according to the preset power, and the airflow generating element 11 to operate according to the preset speed, and as a result, the drying apparatus 10 may achieve its purpose of the corresponding operation mode.
S237: obtaining a controlled speed by decreasing the preset speed.

According to relevant aerodynamic equation, the air temperature is also related to the volume of the air under the premise that the ambient pressure is constant. For example, the power value of the heating element 12 is Wₑ, the volume of air forming an airflow at the airflow generating element 11 per unit time is S1, and the corresponding air temperature is TC₁. If the power value of the heating module 12 is kept unchanged W_{c}, the volume of air that reduces the speed of the airflow generating element 11 so that it forms an airflow per unit time is S2, and the corresponding air temperature is TC₂. Since the air volume S2 is less than the air volume S1, the air temperature TC₂ greater than TC₁ will be caused by the same total heat input. In other words, the air temperature control on the output airflow of the drying apparatus 10 can be achieved by changing the power value of the heating element 12, and can also be achieved by changing the rotational speed of the airflow generating element 11.

Based on the above-mentioned principle, when the control power exceeds the power upper limit of the heating element 12 (for example, step S234, step S231), the control speed may decrease from the preset speed. The main control module 14 controls the airflow generating element 11 with the control speed to reduce the volume of air forming an airflow per unit time.
S238: controlling the heating element 12 to operate according to the power upper limit, and the airflow generating element 11 to operate according to the controlled speed.

The main control module 14 controls the airflow generating element 11 to operate according to a control speed, the heating element 12 to operate according to the power upper limit, making the drying apparatus 10 reduce the total volume of the output airflow in this operation mode, improving the air temperature to a certain extent, and indirectly achieving the theoretical air temperature or drying time corresponding to the control power.

In the control method of some embodiments, only a preset ambient pressure and a corresponding set of control parameters can be set, and after obtaining the ambient pressure, according to the size of the difference between the ambient pressure and the preset ambient pressure, the corresponding control power and/or the control speed are determined with a preset function.

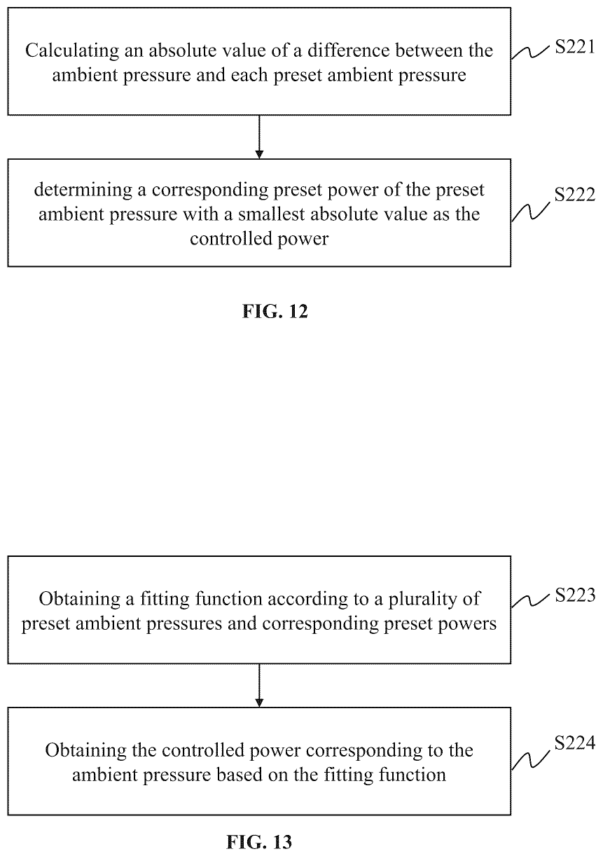

In some embodiments of the control method shown in FIG. 12, a count of preset ambient pressures is plurality, with each has a corresponding preset power. For example, in a laboratory capable of changing ambient pressure, the various operating modes of the drying apparatus 10 are calibrated in different preset ambient pressures. The control parameters of each operation mode of the drying apparatus 10 are calibrated in a plurality of preset ambient pressures by software simulation, or manually in a plurality of laboratories at different altitudes.

Correspondingly, S22: obtaining a preset power, comprising:
S221: calculating an absolute value of a difference between the ambient pressure and each preset ambient pressure.
S222: determining a corresponding preset power of the preset ambient pressure with a smallest absolute value as the controlled power.

In the above-mentioned embodiment, a plurality of preset ambient pressures is configured during the design of the drying apparatus 10, such preset ambient covering the ambient pressure range of human habitation, and the control parameters of each operation mode of the drying apparatus 10 are calibrated respectively in these preset ambient pressures. When the user operates the drying apparatus 10 to switch to a certain operation mode, the main control module 14 selects a preset power corresponding to the closest preset ambient pressure by calculating an absolute value of the interpolation between the detected ambient pressure with each preset ambient pressure. The power is then controlled to adapt the drying apparatus 10 to the actual ambient pressure.

In the above-mentioned embodiment, the more the number of preset ambient pressure, theoretically the more accurate the control of drying apparatus 10. But this may bring the issue that data quantity is large, and workload at early stage is large.

In some other embodiments of the control method, as shown in FIG. 13, the count of preset ambient pressures is plurality, with each preset ambient pressure having a corresponding preset power.
S22: obtaining a preset power, comprising:
S223: obtaining a fitting function according to a plurality of preset ambient pressure and corresponding preset powers;

Fitting is a series of points on a plane connected by a smooth curve, which may also be represented by a function, that is, a fitting function. A fitting function is a type of data processing that builds a mathematical model with limited preset data. Commonly used fitting methods include least squares curve fitting.

For example, during the design of Drying Apparatus 10, after obtaining the corresponding preset power in a plurality of preset ambient pressures, in the plane coordinate system, a plurality of points are drawn with the ambient pressure value as the abscissa, and the power value is the ordinate, and the coordinates of each point are (preset ambient pressure, preset power), and then the fitting function f(p)=w is obtained by connecting each point with a smooth curve, wherein the independent variable p is the ambient pressure value, and w is the corresponding power value.
S224: obtaining the controlled power corresponding to the ambient pressure based on the fitting function.

After obtaining the fitting function, the ambient pressure measured by the barometer 13 is brought into the fitting function, from which the corresponding control power may be determined by calculation. For example, when the user operates the drying apparatus 10, the barometer 13 obtains the ambient pressure at the level of pₓ, which is brought into the fitting function f(pₓ) to determine the control power wₓ corresponding to the ambient pressure pₓ.

In other embodiments, the corresponding function may also be obtained by interpolation, and the corresponding control power is obtained according to the ambient pressure.

In the above-mentioned embodiment, the number of preset ambient pressures may be reduced, and the control power is obtained by real-time calculation based on function. The amount of data requirement is small, and workload at early stage is small.

The control method in other embodiments may also be combined with the above two modes. For example, during the design of the drying apparatus 10, corresponding preset power Wₓ₁, Wₓ₂, Wₓ₃, etc. are calibrated in a plurality of preset ambient pressures Pₓ₁, Pₓ₂, Pₓ₃, etc. After the drying apparatus 10 obtains the ambient pressure Pₓ during operation, it calculates the closest preset ambient pressure Pₓₙ and the corresponding preset power Wₓₙ based on the absolute value of the difference. According to the difference between the ambient ambient pressure Pₓ and the preset ambient pressure Pₓₙ, the preset power Wₓₙ in reference may be amended through calculation. For example, the amendment may be calculated according to a preset function f(Pₓ−Pₓₙ), and the preset power Wₓₙ in reference is amended according to the amendment to obtain the control power Wₓ. In this way, both pros and cons of the above two methods may be combined to reduce the amount of data needed and workload at early stage needed.

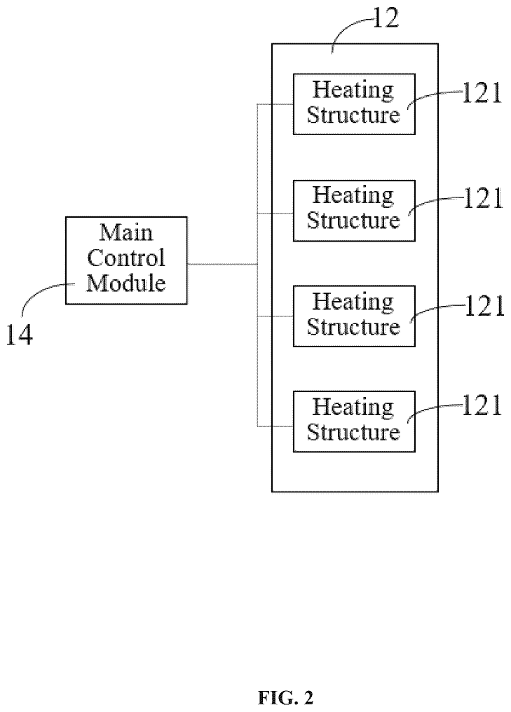

As shown in FIG. 1 and FIG. 2, in some embodiments, the heating element 12 of the drying apparatus 10 may comprise a plurality of heating structures 121, which may be made of heating wires at preset length or electric heating sheets at preset area. The plurality of heating structures 121 may have the same or different rated power, and may be combined in series or parallel, or may be independent of each other. The main control module 14 may control the heating element 12 by any of the following two modes:
(1) the main control module 14 controls the opening and closing of any of the heating structure 121. For example, the heating element 12 comprises four identical heating structures 121. When the main control module 14 closes one of the heating structures 121 and opens the remaining three, the heating element 12 may operate at 75% of its maximum power. Alternatively, the heating element 12 comprises a first group of heating structures 121 with a rated total power of Wₐ and a second group of heating structures 121 with a rated total power of 2Wₐ; the main control module 14 closes the first group with a rated total power of Wₐ and opens the second group with a rated total power of 2Wₐ, and the heating elements 12 may operate at 67% of its maximum power.
(2) the main control module 14 controls the power of any of the heating structure 121. For example, the heating element 12 comprises two groups of identical heating structures 121. When the main control module 14 controls the power of one of the groups of heating structures 121 at 50% of its maximum power, and the power of the other group of heating structures 121 at 100% of its maximum power, the heating element 12 operates overall at 75% of its maximum power.

The main control module 14 may also combine the above two modes for the control of the heating element 12. For example, the heating element 12 comprises two identical sets of heating structures 121, then the main control module 14 may control the heating element 12 in the following way: one of the sets of heating structures 121 is turned off, the input power of the other set of heating structures 121 is 50% of its maximum power, and the heating element 12 operates overall at 25% of its maximum power.

In some embodiments, as shown in FIG. 1 and FIG. 4, the drying apparatus 10 further comprises a housing 16, in which an airflow channel 164 is configured, and the airflow generating element 11 generates airflow in the airflow channel 164. The airflow channel 164 is a space enclosed by side walls, which defines the size of the cross-section of the airflow formed inside the drying apparatus 10. Correspondingly, the diameter of the impeller of the airflow generating element 11 is slightly smaller than the airflow cross-section so that sufficient work may be done to the air within the airflow channel 164. Combined with the impeller speed and the cross-sectional dimensions of the airflow of the airflow generating element 11, the volume of the airflow passing through the drying apparatus 10 per unit time may be calculated.

The barometer 13 needs to in contact with air outside to obtains the ambient pressure. If the barometer 13 is directly configured on the outer surface of the housing 16, although the requirement of contact with the air outside may be satisfied, the drying apparatus 10 may not have consistent aesthetic appearance. Moreover, the barometer 13 exposed may also have a risk of being easily damaged. Therefore, in some embodiments, the barometer 13 is configured within the airflow channel 164 so that it may be in contact with the air in the airflow channel 164 and obtain the ambient pressure. The barometer 13 hidden inside of the housing 16 may not affect the aesthetic appearance of the drying apparatus 10, and is not easy to be damaged.

In some embodiments, the ultra-high-speed motor adopted by the airflow generating element 11 generates a high-speed airflow in the airflow channel 164 during operation. When the high-speed airflow passes through the barometer 13, it may affect the ambient pressure measured which may deviate from the actual ambient pressure. To mitigate this, the control method in some embodiments, before S10: obtaining the ambient pressure through the barometer 13, further comprises:
when the airflow generating element 11 is not operating or its operation time is less than a preset value, obtaining the ambient pressure through the barometer 13.

In some embodiments, when the airflow generating element 11 is not in operation, there is no high-speed airflow in the airflow channel 164. At this time, the barometer 13 may accurately detect and obtain the ambient pressure.

In some embodiments, a short delay time, such as 0.1 seconds, 0.3 seconds, 0.5 seconds, 0.8 seconds, 1 second, 1.5 seconds, may be set after the drying apparatus 10 starts operation in 2 seconds, 3 seconds, etc. After the delay time is reached, the airflow generating element 11 starts operation, that is, the time of output airflow of the drying apparatus 10 is delayed. During this delay time, no airflow is generated in the airflow channel 164, and the barometer 13 may accurately obtain the ambient pressure.

In some embodiments, the obtaining time of the barometer 13 is set within a short preset time after the drying apparatus 10 starts operation. For example, the preset time may be set at 0.1 second, 0.3 seconds, 0.5 seconds, 0.8 seconds, 1 second, 1.5 seconds, 2 seconds, 3 seconds, etc. after the drying apparatus 10 starts operation. After the preset time, the high-speed airflow formed by the airflow generating element 11 has not yet reached its maximum airflow speed, and its impact on the ambient pressure is small. Therefore, when the barometer 13 obtains the ambient pressure in this preset time period, it may avoid being affected by the high-speed airflow, so that the ambient pressure can be measured more accurately.

As shown in FIG. 1, FIG. 2, and FIG. 4, in some embodiments, the heating element 12 comprises a first component 124 and a second component 123. Along the direction of the airflow (e.g., the direction of the arrow in FIG. 4), the first component 124 is configured upstream of the airflow generating element 11 and the second component 123 is configured downstream of the airflow generating element 11. The first component 124 may be composed of one or more of the aforesaid heating structures 121 in series and/or parallel, and the second component 123 may also be composed of one or more of the aforesaid heating structures 121 in series and/or parallel. The structure and power of the first component 124 and the second component 123 may be the same or different. The main difference between the two lies in their position relative to the airflow generating element 11 in the airflow channel. It is easy to understand that the control of the heating element 12 by the main control module 14 may also comprise the control of opening and closing or input power of the first component 124 and the second component 123 respectively. When the first component 124 and the second component 123 operates simultaneously, it is equivalent to heating the airflow at two positions of the airflow channel, so that the heating element 12 has a larger heat exchange region and a higher heating efficiency.

However, when the first component 124 is operating, the airflow heated by it passes through the airflow generating element 11, thereby causing the airflow generating element 11 to operate in a hot airflow, which may affect the performance and the life of the airflow generating element 11. Therefore, when the main control module 14 controls the heating element 12 according to the control power, if the control power is lower than a first threshold (e.g., the first threshold is roughly equivalent to the maximum power of the second component 123), the control power may be completely reached by the second component 123. At this moment, the control strategy of the main control module 14 is to close the first component 124, open the second component 123 only, and control its operation to reach the control power. In this way, the main control module 14 may be preferentially shut down the first component 124 under certain working conditions, so that the airflow generating element 11 will not operate in the heated airflow under these working conditions, so as to prolong the life of the airflow generating element 11.

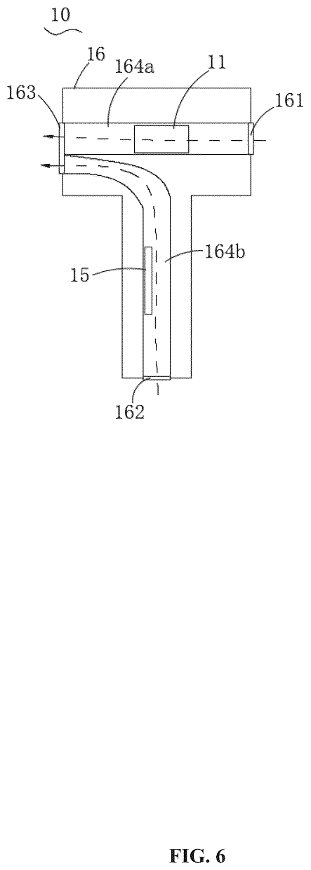

In a more specific embodiment, as shown in FIG. 5 or FIG. 6, the housing 16 of the drying apparatus 10 comprises a first air inlet 161, a second air inlet 162, and an air outlet 163. The airflow channel 164 comprises a first airflow duct 164a and a second airflow duct 164b. The first airflow duct 164a is configured between the first air inlet 161 and the air outlet 163. The airflow generating element 11 is configured in the first airflow duct 164a. During operation, the airflow is directly generated in the first airflow duct 164a. The airflow then enters the housing 16 from the first air inlet 161, passes through the first airflow duct 164a, and emits out of the housing 16 from the air outlet 163.

In the embodiment shown in FIG. 5, the upstream of the second airflow duct 164b is coupled to the second air inlet 162, and the downstream is coupled to the first airflow duct 164a. After the airflow generating element 11 generates an airflow in the first airflow duct 164a, a negative pressure downstream of the second airflow duct 164b is formed, thereby the air outside the housing 16 passing from the second air inlet 162, through the second airflow duct 164b, and finally into the first airflow duct 164a.

In the embodiment shown in FIG. 6, the upstream of the second airflow duct 164b is coupled to the second air inlet 162, and the downstream is coupled to the air outlet 163. After the airflow generating element 11 generates an airflow in the first airflow duct 164a, a negative pressure is formed at the air outlet 163, so that the air outside the housing 16 passes into the second air inlet 162, along the second airflow duct 164b, and finally out from the air outlet 163.

In the embodiments shown in FIG. 5 and FIG. 6, because the airflow generating element 11 is configured in the first airflow duct 164a, the air in the second airflow duct 164b may be indirectly affected by the airflow generating element 11 and thereby forms another airflow. The airflow speed of the airflow in the second airflow duct 164b is smaller than that in the first airflow duct 164a.

As shown in FIG. 1, FIG. 5, and FIG. 6, in some embodiments of the drying apparatus 10, the barometer 13 is configured in the second airflow duct 164b, because the airflow speed of the airflow in the second airflow duct 164b is smaller, its impact on the ambient pressure is also small, and the ambient pressure may be obtained more accurately through the barometer 13. In some embodiments, the barometer 13 may also be configured in the first airflow duct 164a. Because the airflow speed of the airflow in the first airflow duct 164a is larger, in order to mitigate its impact on the ambient pressure, the preceding control method may be adopted, that is, the ambient pressure is obtained through the barometer 13 when the airflow generating element 11 is not operating or the operating time is less than the preset value.

It is easy to understand that, in some embodiments, the airflow in the second airflow duct 164b may also have an impact on the ambient pressure, so that there is an error in the ambient pressure obtained through the barometer 13. Similarly, a similar mode as described above may be adopted. For example, the airflow generating element 11 is not operating or the operating time is less than the preset value of detection, etc., so that the impact of high-speed airflow on the detection accuracy of the barometer 13 may be mitigated.

As shown in FIG. 1, FIG. 5, and FIG. 6, in a more specific embodiment, the drying apparatus 10 further comprises a control circuit 15 configured in the second airflow duct 164b. The barometer 13 and the main control module 14 are all configured on the control circuit 15. The control circuit 15 is electrically coupled to the airflow generating element 11 and the heating element 12. The control circuit 15 comprises a main circuit structure inside the drying apparatus 10. When the drying apparatus 10 is operating, the airflow in the second airflow duct 164b passes through the whole control circuit 15. Besides making the barometer 13 more accurate in obtaining the ambient pressure, the airflow may also dissipate heat of the control circuit 15, and the control circuit 15 is prevented from overheating. Because the airflow speed in the second airflow duct 164b is comparatively lower than that in the first airflow duct 164a, the control circuit 15 is configured in the second airflow duct 164b and does not produce significant airflow noise.

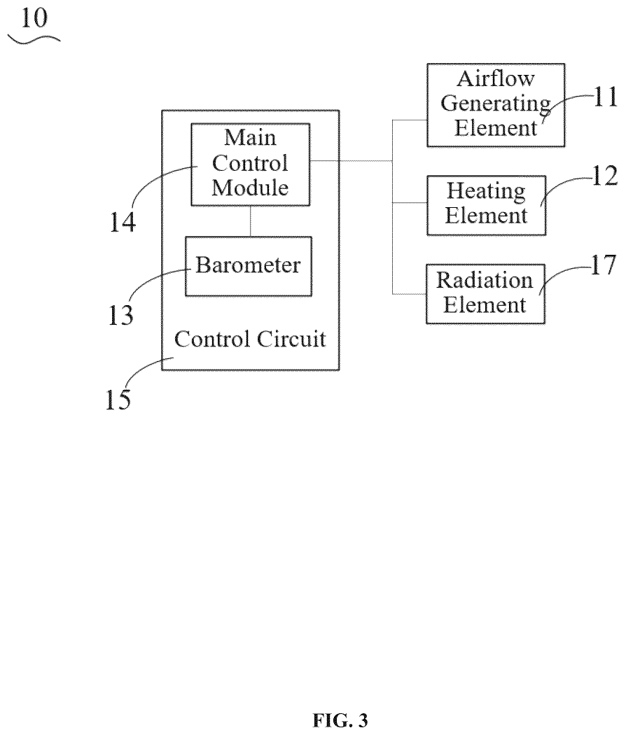

As shown in FIG. 3, in some embodiments, the drying apparatus 10 further comprises a radiation element 17 configured to generate infrared radiation. The radiation element 17 is coupled to the main control module 14, and the main control module 14 is configured to adjust operating power of the radiation element 17 according to the ambient pressure. The radiation element 17 may generate the infrared radiation of the preset wavelength band upon input current, and directly dry the target object.

Accordingly, the control methods in some embodiments of the present disclosure further comprise the following steps:
determining whether the ambient pressure is below a threshold;

Because the radiation element 17 also generates heat on its own when it is operating. According to the impact of the above-mentioned air temperature on ambient pressure, in an environment with low ambient pressure, the radiation element 17 is more likely to heat the nearby airflow to a higher temperature, so that the heat dissipation efficiency of the radiation element 17 is reduced. Not only is the radiation element 17 easy to overheat, but it may also make the whole drying apparatus 10 overheated, which may burn the user. Moreover, according to the principle of blackbody radiation, the spectral drift of the radiation element 17 may also occur when it operates at a higher temperature. The wavelength of the infrared radiation emitted therefore may change, and the drying time may be affected. To mitigate it, the ambient pressure of the radiation element 17 with low heat dissipation efficiency is determined in advance through simulation and experiments, and stored as a threshold.

If the ambient pressure is lower than the threshold, reducing an operating power of the radiation element

[symbol]

During the operation of the drying apparatus 10, when the ambient pressure obtained through the barometer 13 is lower than the threshold, the main control module 14 may reduce the current operating power of the radiation element 17 accordingly. In this way, on the one hand, an overheated of the radiation element 17 and a hot drying apparatus 10 may be avoided; and on the other hand, the radiation element 17 may be kept in a suitable operating temperature range, so that the infrared radiation of the preset wavelength is guaranteed to be emitted by the radiation element 17.

It is easy to understand that, similar to the radiation element 17, the drying apparatus 10 may also be configured with other power-consuming components in other embodiments, such as negative ion components, hair-care essential oil components, etc., and these power-consuming components themselves may also necessarily generate heat when in operation, so that the heat generated of the whole drying apparatus 10 is higher. Because a lower ambient pressure will decease the heat dissipation efficiency of the drying apparatus 10, the main control module 14 needs to adjust the power of all power-consuming components of the drying apparatus 10 according to the ambient pressure, so as to ensure the heat dissipation efficiency of the whole drying apparatus 10 and avoid overheating of the housing 16.

Some embodiments of the present disclosure also provide a readable storage medium, the readable storage medium stores a program, and each step of the preceding control method is implemented when the program is executed by a processor.

A person skilled in the art may understand that all or part of the process in the method for implementing the above embodiments can be completed by instructing the relevant hardware through a computer program, that the computer program can be stored in a non-volatile computer-readable storage medium, and that the computer program, when executed, may include a process such as the embodiments of the above methods. Therein, any reference to memory, storage, database, or other medium used in each embodiment provided in the present disclosure may include non-volatile and/or volatile memory. Non-volatile memory can include read-only memory (ROM), programmable ROM (PROM), electrically programmable ROM (EPROM), electrically erasable programmable ROM (EEPROM), or flash memory. Volatile memory may include random access memory (RAM) or external cache memory. As an illustration rather than a limitation, RAM is available in a variety of forms, such as Static RAM (SRAM), Dynamic RAM (DRAM), Synchronous DRAM (SDRAM), Dual Data Rate SDRAM (DDRSDRAM), Enhanced SDRAM (ESDRAM), Synchlink DRAM (SLDRAM), Memory Bus (Rambus) Direct RAM (RDRAM), Direct Memory Bus Dynamic RAM (DRDRAM), and Memory Bus Dynamic RAM (RDRAM), etc.

In the description of this specification, references to the terms “one embodiment”, “some embodiments”, “schematic embodiments”, “examples”, “specific examples” or “some examples”, etc., are intended to mean that the specific features, structures, materials or features described in conjunction with the embodiments or examples are contained in at least one embodiment or example of the present disclosure. In this specification, indicative representations of the above terms do not necessarily refer to the same embodiments or examples. Further, the specific features, structures, materials, or features described may be combined in an appropriate manner in any one or more embodiments or examples. In addition, without contradicting each other, those skilled in the art may combine and combine the different embodiments or examples described in this specification and the features of the different embodiments or examples.

Any process or method description described in a flowchart or otherwise herein may be understood to mean a module that includes one or more executable instructions for the implementation of a particular logical function or process, fragments or parts, and the scope of the preferred embodiment of the present disclosure includes additional implementations, which may not be in the order shown or discussed, including the performance of functions in a substantially simultaneous manner or in reverse order according to the functions involved, which shall be understood by those skilled in the art to which the embodiments of the present disclosure belong.

Notwithstanding the above illustrations and descriptions of the embodiments of the present disclosure, it is understood that the said embodiments are illustrative and cannot be construed as limiting the present disclosure, and those skilled in the art may change, modify, replace and variate the said embodiments within the scope of the present disclosure.

What is claimed is:

1. A drying apparatus, the drying apparatus comprising:
an airflow generating element configured to generate an airflow;
a heating element configured to heat the airflow;
a barometer configured to obtain an ambient pressure; and
a main control module coupled to the heating element and the barometer, wherein the main control module is configured to control the airflow generating element or the heating element according to the ambient pressure.

2. The drying apparatus of claim 1, wherein the heating element comprises a plurality of heating structures, and the main control module is configured to power each heating structure on/off or its power value.

3. The drying apparatus of claim 1, further comprising:
a housing in which an airflow channel is configured, wherein the airflow generating element is configured to generate the airflow in the airflow channel.

4. The drying apparatus of claim 3, wherein the barometer is configured in the airflow channel.

5. The drying apparatus of claim 3, wherein the heating element comprises:
a first component configured in the airflow channel and upstream of the airflow generating element; and
a second component configured in the airflow channel and downstream of the airflow generating element.

6. The drying apparatus of claim 3, wherein the housing comprises a first air inlet, a second air inlet, and an air outlet, and the airflow channel further comprises:
a first airflow duct configured between the first air inlet and the air outlet;
a second airflow duct, wherein the second airflow duct's upstream is coupled to the second air inlet, and the second airflow duct's downstream is coupled to the first airflow duct or the air outlet;
wherein the airflow generating element is configured in the first airflow duct; and
wherein the barometer is configured in the first airflow duct or the second airflow duct.

7. The drying apparatus of claim 6, further comprising:
a control circuit, wherein the control circuit is configured in the second airflow duct, the barometer and the main control module are configured on the control circuit, and the control circuit is electrically coupled to the airflow generating element and the heating element.

8. The drying apparatus of claim 1, further comprising:
a radiation element configured to generate infrared radiation, wherein the radiation element is coupled to the main control module, and the main control module is configured to adjust operating power of the radiation element according to the ambient pressure.

9. A method for controlling a drying apparatus, wherein the drying apparatus comprises:
an airflow generating element configured to generate an airflow;
a heating element configured to heat the airflow;
a barometer configured to obtain an ambient pressure; and
a main control module coupled to the heating element and the barometer, wherein the main control module is configured to control the airflow generating element or the heating element according to the ambient pressure,
the method comprising:
obtaining the ambient pressure through the barometer; and
controlling the airflow generating element or the heating element according to the ambient pressure.

10. The method of claim 9, wherein the controlling the airflow generating element or the heating element according to the ambient pressure, comprises:
determining an operation mode;
obtaining a preset power, wherein the preset power is a power value of the heating element when the drying apparatus operates in the operation mode at a preset ambient pressure;
obtaining a control power from the preset power according to a relationship between the ambient pressure and the preset ambient pressure; and
controlling the heating element according to the control power.

11. The method of claim 10, wherein the operation mode corresponds to an air temperature, and the air temperature is configured to characterize temperature of an output airflow of the drying apparatus,
wherein obtaining the control power from the preset power comprises:
if the ambient pressure is greater than the preset ambient pressure, obtaining the control power by increasing the preset power; or
if the ambient pressure is less than the preset ambient pressure, obtaining the control power by decreasing the preset power.

12. The method of claim 10, wherein the operation mode corresponds to a drying time, and the drying time is configured to characterize time taken by the drying apparatus to dry a target from a first moisture level to a second moisture level,
wherein obtaining the control power from the preset power comprises:
if the ambient pressure is greater than the preset ambient pressure, obtaining the control power by decreasing the preset power; or
if the ambient pressure is less than the preset ambient pressure, obtaining the control power by increasing the preset power.

13. The method of claim 10, wherein the controlling the airflow generating element or the heating element according to the ambient pressure, further comprises:
if the control power is greater than a power upper limit of the heating element,
obtaining a preset speed, the preset speed being a speed at which the airflow generating element operates when the drying apparatus operates in the operation mode at the preset ambient pressure;
obtaining a controlled speed by decreasing the preset speed; and
controlling the heating element to operate according to the power upper limit, and the airflow generating element to operate according to the controlled speed.

14. The method of claim 10, wherein a count of preset ambient pressures is plurality,
wherein obtaining the preset power comprises:
calculating an absolute value of a difference between the ambient pressure and each preset ambient pressure; and
determining a corresponding preset power of the preset ambient pressure with a smallest absolute value as the controlled power.

15. The method of claim 10, wherein a count of preset ambient pressures is plurality,
wherein obtaining the preset power comprises:
obtaining a fitting function according to a plurality of preset ambient pressures and corresponding preset powers; and
obtaining the controlled power corresponding to the ambient pressure based on the fitting function.

16. The method of claim 9, wherein the drying apparatus comprises a radiation element, and the method further comprises:
determining whether the ambient pressure is below a threshold; and
if the ambient pressure is lower than the threshold, reducing an operating power of the radiation element.

17. The method of claim 9, wherein the barometer is configured in an airflow channel configured by the airflow generating element, and before obtaining the ambient pressure through the barometer, the method further comprises:
when the airflow generating element is not operating or the airflow generating element's operation time is less than a preset value, obtaining the ambient pressure through the barometer.

18. A non-transitory computer readable medium, comprising at least one set of instructions for controlling a drying apparatus, wherein the drying apparatus comprises:
an airflow generating element configured to generate an airflow;
a heating element configured to heat the airflow;
a barometer configured to obtain an ambient pressure; and
a main control module coupled to the heating element and the barometer, wherein the main control module is configured to control the airflow generating element or the heating element according to the ambient pressure,
wherein when executed by at least one processor of a computing device, the at least one set of instructions direct the at least one processor to perform operations including:
obtaining the ambient pressure through the barometer; and
controlling the airflow generating element or the heating element according to the ambient pressure.

19. The non-transitory computer readable medium of claim 18, wherein the controlling the airflow generating element or the heating element according to the ambient pressure, comprises:
determining an operation mode;
obtaining a preset power, wherein the preset power is a power value of the heating element when the drying apparatus operates in the operation mode at a preset ambient pressure;
obtaining a control power from the preset power according to a relationship between the ambient pressure and the preset ambient pressure; and
controlling the heating element according to the control power.

20. The non-transitory computer readable medium of claim 18, wherein the drying apparatus comprises a radiation element, and the at least one set of instructions further direct the at least one processor to perform operations including:
determining whether the ambient pressure is below a threshold; and
if the ambient pressure is lower than the threshold, reducing an operating power of the radiation element.
